(19) United States
(12) Patent Application Publication
(10) Pub. No.: US 2024/0323735 A1
(43) Pub. Date: Sep. 26, 2024

(54) METHOD AND APPARATUS FOR FULL-DUPLEX WIRELESS COMMUNICATION SYSTEMS

(71) Applicant: Samsung Electronics Co., Ltd., Suwon-si, Gyeonggi-do (KR)

(72) Inventors: Ameha Tsegaye ABEBE, Suwon-si (KR); Youngrok JANG, Suwon-si (KR); Younsun KIM, Suwon-si (KR); Seongmok LIM, Suwon-si (KR); Hyoungju JI, Suwon-si (KR)

(21) Appl. No.: 18/577,886

(22) PCT Filed: Jul. 22, 2022
(86) PCT No.: PCT/KR2022/010827

§ 371 Date: Jan. 9, 2024

(30) Foreign Application Priority Data
Jul. 23, 2021 (KR) 10-2021-0097337

(51) Int. Cl. H04W 24/10

(52) U.S. Cl. CPC H04W 24/10

(57) ABSTRACT

The disclosure relates to a 5G or 6G communication system for supporting a higher data transmission rate. A user equipment (UE) in a communication system is provided. The UE comprises a transceiver and a controller configured to receive, from a base station, configuration information associated with a multiple transmit-receive points (TRPs): identify amplitude coefficients associated with the multiple TRPs based on the configuration information; and transmit, to the base station, a channel state information (CSI) report includes indicators indicating the amplitude coefficients associated with the multiple TPRs.

### TECHNICAL FIELD

The present disclosure relates to the field of 5G communication networks and more particularly to a full-duplex communication in distributed multiple-input multiple-output (MIMO) system.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The principal object of the disclosure herein is to disclose methods and apparatus for full-duplex operation in distributed multiple-input multiple-output (MIMO)-based communication network, wherein the communication network is at least one of the Fifth Generation (5G) standalone network and a 5G non-standalone (NAS) network.

As specific object of the disclosure herein is to disclose methods and systems to enable antenna ports of a g-NodeB (gNB) to operate in either half- or full-duplex mode based on the channel measurement as well cross-link and/or self-interference measurements and reports.

Another objective of the disclosure herein is to enable a UE to select a downlink transmission antenna ports of gNB to report channel state information (CSI) to receive a downlink data transmission in physical downlink shared channel (PDSCH).

Another objective of the disclosure is to enable a UE to select among multiple antenna panels of a gNB that can be used for downlink coherent joint transmission (CJT). In particular, a codebook is disclosed with which a downlink data transmission can be jointly precoded across a spatially distributed panels.

### Solution to Problem

The present disclosure has been made to address the above-mentioned problems and disadvantages, and to provide at least the advantages described below.

In accordance with an aspect of the present disclosure, a user equipment (UE) in a communication system is provided. The UE comprises a transceiver and a controller configured to receive, from a base station, configuration information associated with a multiple transmit-receive points (TRPs), identify amplitude coefficients associated with the multiple TRPs based on the configuration information, and transmit, to the base station, a channel state information (CSI) report includes indicators indicating the amplitude coefficients associated with the multiple TPRs.

In accordance with another aspect of the present disclosure, a base station in a communication system is provided. The base station comprises a transceiver and a controller configured to transmit, to a user equipment (UE), configuration information associated with a multiple transmit-receive points (TRPs), and receive, from the UE, a channel state information (CSI) report includes indicators indicating the amplitude coefficients associated with the multiple TPRs based on the configuration information.

In accordance with another aspect of the present disclosure, a method performed by a user equipment (UE) in a communication system is provided. The method comprises receiving, from a base station, configuration information associated with a multiple transmit-receive points (TRPs); identifying amplitude coefficients associated with the multiple TRPs based on the configuration information; and transmitting, to the base station, a channel state information (CSI) report includes indicators indicating the amplitude coefficients associated with the multiple TPRs.

In accordance with another aspect of the present disclosure, a method performed by a base station in a communication system is provided. The method comprises transmitting, to a user equipment (UE), configuration information associated with a multiple transmit-receive points (TRPs); and receiving, from the UE, a channel state information (CSI) report includes indicators indicating the amplitude coefficients associated with the multiple TPRs based on the configuration information.

### Advantageous Effects of Invention

Embodiments of present disclosure provide methods and apparatus for full-duplex operation in distributed multiple-input multiple-output (MIMO)-based communication network, wherein the communication network is at least one of the Fifth Generation (5G) standalone network and a 5G non-standalone (NAS) network.

Embodiments of present disclosure provide methods and apparatus to enable antenna ports of a g-NodeB (gNB) to operate in either half- or full-duplex mode based on the channel measurement as well cross-link and/or self-interference measurements and reports.

Embodiments of present disclosure provide methods and apparatus to enable a UE to select a downlink transmission antenna ports of gNB to report channel state information (CSI) to receive a downlink data transmission in physical downlink shared channel (PDSCH).

Embodiments of present disclosure provide method and apparatus to enable a UE to select among multiple antenna panels of a gNB that can be used for downlink coherent joint transmission (CJT). In particular, a codebook is disclosed with which a downlink data transmission can be jointly precoded across a spatially distributed panels.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates an example wireless network.

FIG. 2A illustrates an example wireless transmit path according to embodiments of the present disclosure.

FIG. 2B illustrates an example wireless receive path according to embodiments of the present disclosure.

FIG. 3A illustrates an example UE according to embodiments of the present disclosure.

FIG. 3B illustrates an example gNB according to embodiments of the present disclosure.

FIG. 4 illustrates exemplary scenarios and configuration of full-duplex system.

FIG. 5 illustrates exemplary layout of a distributed multiple-input multiple-output (DMIMO) system with distributed antenna ports.

FIG. 6 illustrates an example of a port to RRH mapping indicator.

FIG. 7 illustrates exemplary DMIMO scenario wherein some antenna ports are not available for downlink transmission.

FIG. 8 illustrates an example for indicator of port availability indicator in a DMIMO system.

FIG. 9 depicts an example for a MAC-CE based indication of available ports in DMIMO system.

FIG. 10 illustrates an exemplary scenario that necessitates such partial CSI report in a DMIMO system.

FIG. 11 illustrates an exemplary time-line and high-level overview of the disclosed invention.

FIG. 12 illustrates an exemplary system where antenna panels are distributed over a transmission area.

FIG. 13 depicts an example for panel to RRH mapping in DMIMO system.

FIG. 14 depicts an example for ports to panel mapping in DMIMO system.

FIG. 15 illustrates an exemplary scenario of multi-panel based DMIMO system wherein a subset of antenna panels is not available for downlink transmission.

FIG. 16 illustrates an exemplary scenario is illustrated to justify why independent DFT beams per each panel should be reported in distributed multi-panel codebook.

### MODE FOR THE INVENTION

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHZ, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

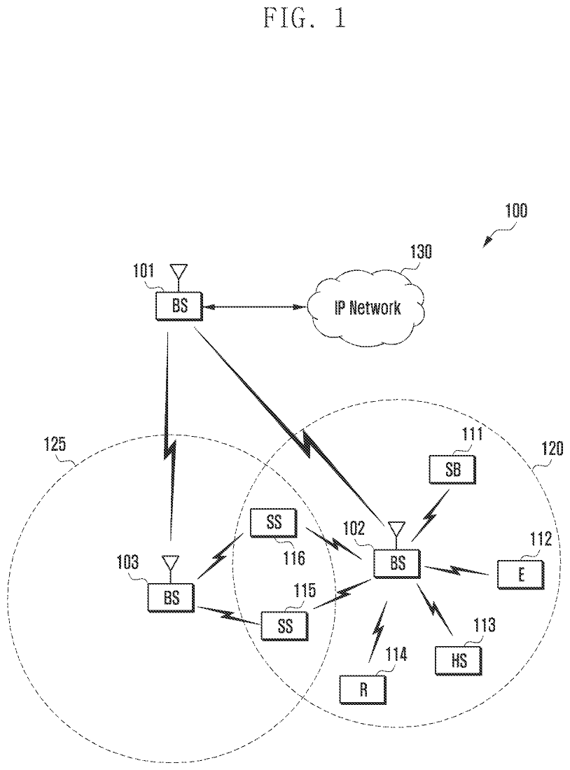

FIG. 1 illustrates an example wireless network 100 according to present disclosure. The embodiment of the wireless network 100 shown in FIG. 1 is for illustration only. Other embodiments of the wireless network 100 can be used without departing from the scope of present disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

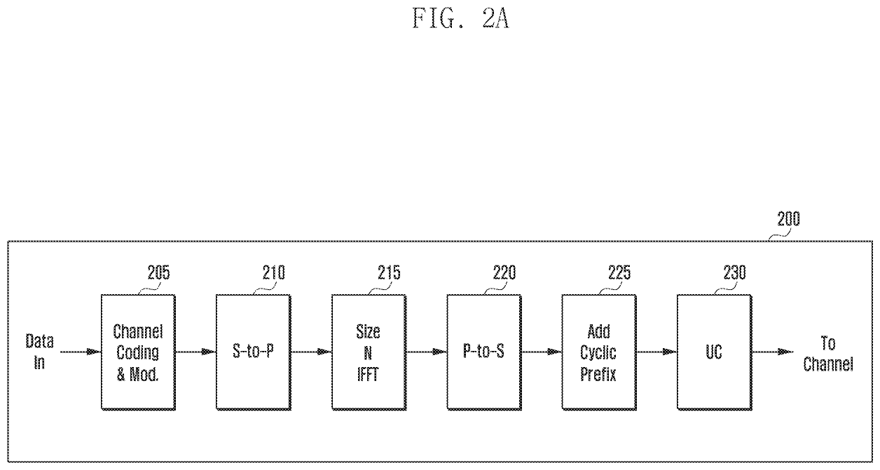

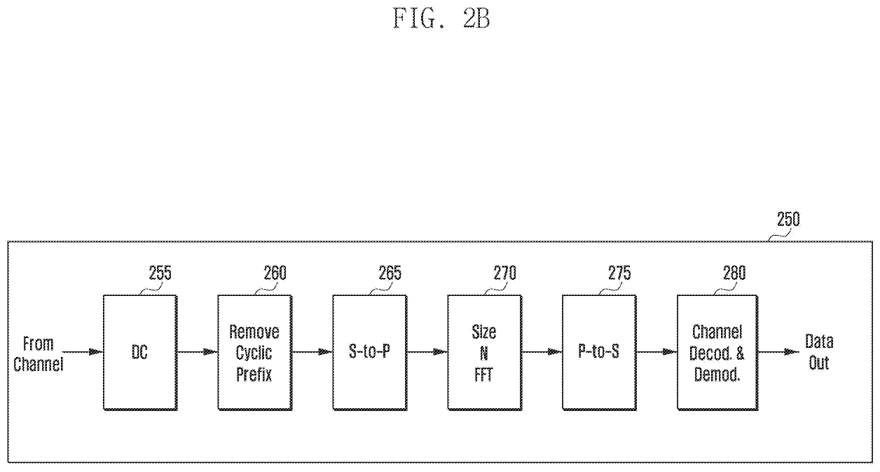

FIGS. 2A and 2B illustrate example wireless transmit and receive paths according to present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial to-parallel (S-to-P) block 210, a size N Inverse Fast Fourier Transform (IFFT) block 215, a parallel-to-serial (P-to-S) block 220, an add cyclic prefix block 225, and an upconverter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

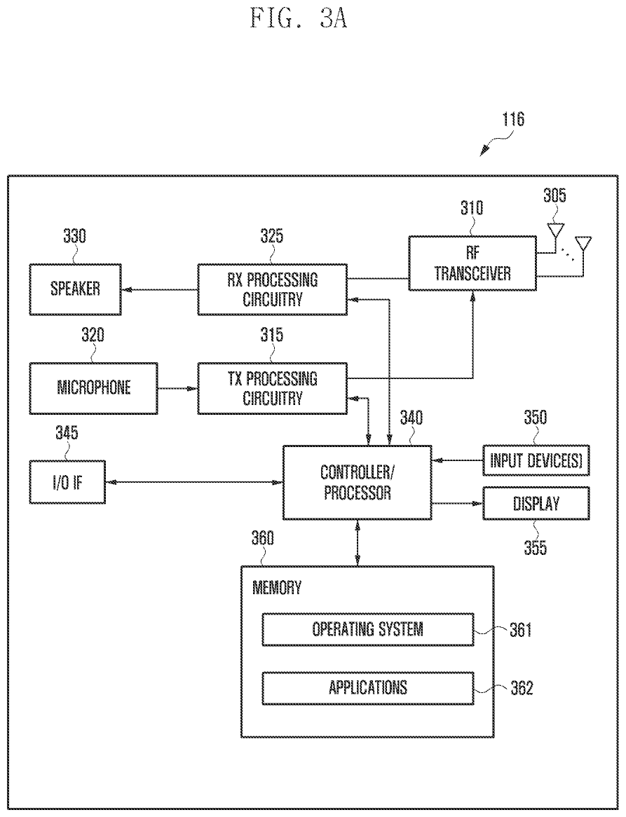

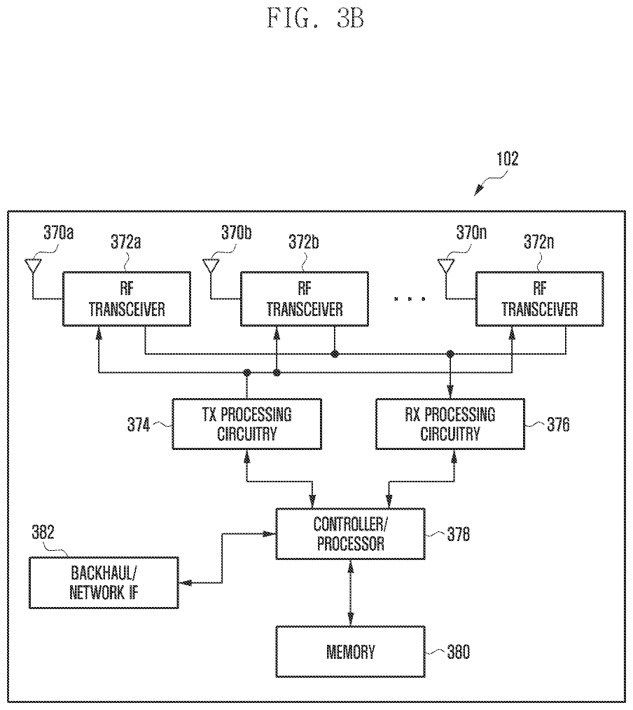

FIG. 3A illustrates an example UE 116 according to present disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of present disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a input device(s) 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the input device(s) 350 and the display unit 355. The operator of the UE 116 can use the input device(s) 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to present disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of present disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of an gNB 102, various changes may be made to FIG. 3B. For example, the gNB 102 can include any number of each component shown in FIG. 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

One of the prominent proposals of the release 18 of the 5th generation mobile communication, also known as a new radio (NR), is cross-division duplex (XDD). XDD allows flexible allocation of radio resources in time and frequency domains for uplink (UL) and downlink (DL) transmission. Consequently, it provides a handful of advantages over fixed duplex modes such as time-division duplexing (TDD) and frequency-domain duplexing (FDD). The advantages include higher resource utilization, shorter latency and UL coverage enhancement.

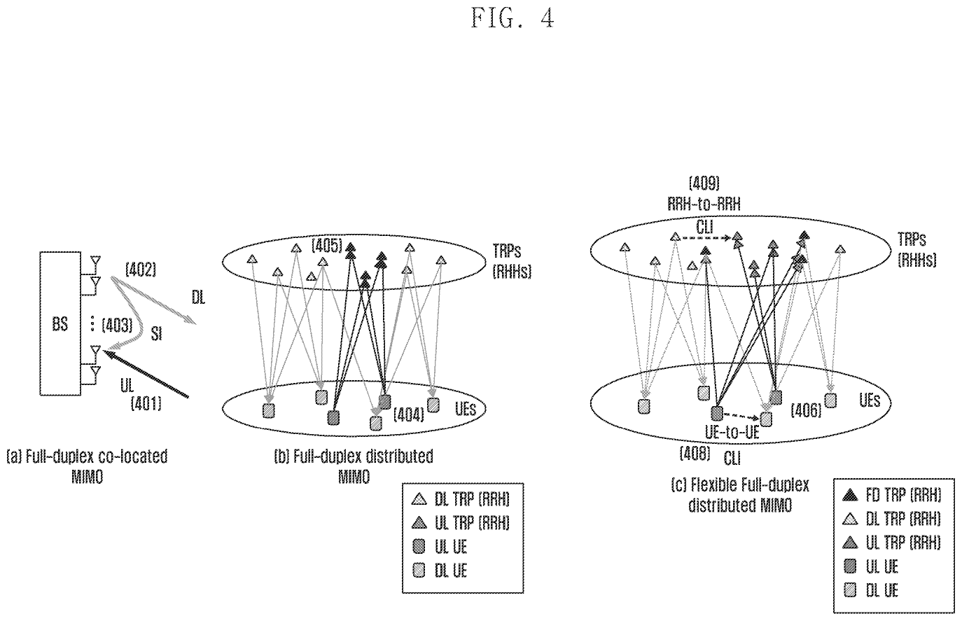

Full-duplex transmission illustrated in FIG. 4 is a specific case of XDD system wherein resources are fully overlapped for uplink (UL) and downlink (DL) transmission. FIG. 4(a) illustrates a full-duplex system in co-located MIMO system at the base station (BS) where antenna ports are physically located together, i.e., attached to the same mast, panel, etc. In this system, UL (401) and DL (402) transmissions are simultaneously performed over the same time-frequency resources. The main performance factor in this system is self-interference (403) between DL and UL transmissions. An analog and digital self-interference mitigation can then be performed at the base-station. One of the limitations of the a full-duplex co-located antenna system is that self-interference mitigation to a certain level, often expressed in terms of decibels (dB), is possible only if the DL transmission power is below a certain level.

Another particular implementation of full-duplex system in the distributed MIMO system is illustrated in FIG. 4(b). In FIG. 4(b), distributed antenna ports (405) wherein the co-located subset of antenna ports can be referred as transmission reception point (TRP) or remote radio head (RRH) are distributed in space and serve a number of users (404) in either UL or DL transmission. In this system, the antenna ports within a single RRH/TRP operate in either UL or DL transmission. On the other hand, if the UL and DL transmissions share the same radio resources, it can be said that the system is a network-level full-duplex system or a full-duplex distributed MIMO system.

Another variation of the system described in FIG. 4(b) is depicted in FIG. 4(c) which can be considered as a flexible full-duplex distributed MIMO. In FIG. 4(c), distributed antenna ports (407) wherein the co-located subset of antenna ports can be referred as transmission reception point (TRP) or remote radio head (RRH) are distributed in space and serve a number of users (406) in either UL or DL transmission. One of the main difference between the system in FIG. 4(c) and the system illustrated in FIG. 4(b) is that each antenna port can operate in either full-duplex or half-duplex mode. The main performance factors for the systems in FIGS. 4(b) and 4(c) are cross-link interference (CLI) between two UEs and CLI between two RRHs, namely UE-to-UE CLI (408) and RRH-to-RRH (409) CLI. In addition, the system in FIG. 4(c) suffers from self-interference (SI) at the RRHs which operate in full-duplex. However, since the DL transmission power from a subset of ports is limited, SI mitigation could easily be fulfilled with as compared to co-located MIMO system in FIG. 4(a).

A description of example embodiments is provided on the following pages.

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

### Part I: Port Selection Codebook-Based Solution

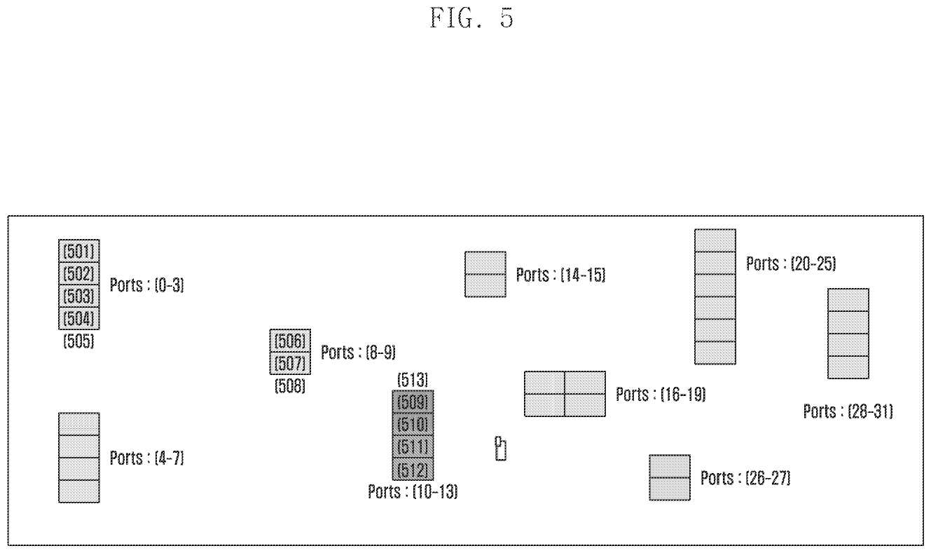

One exemplary layout of a distributed MIMO (DMIMO) system is illustrated in FIG. 5. In this particular example, 32 antenna ports are associated with spatially distributed 9 RRHs. The number of antenna ports attached to a single RRH can be variable. As an example, 4 antenna ports (501)-(504) are attached to a single RRH (505) while 2 antenna ports (506)-(507) are attached to another RRH (508), and 4 antenna ports (509)-(512) are attached to another RRH (513).

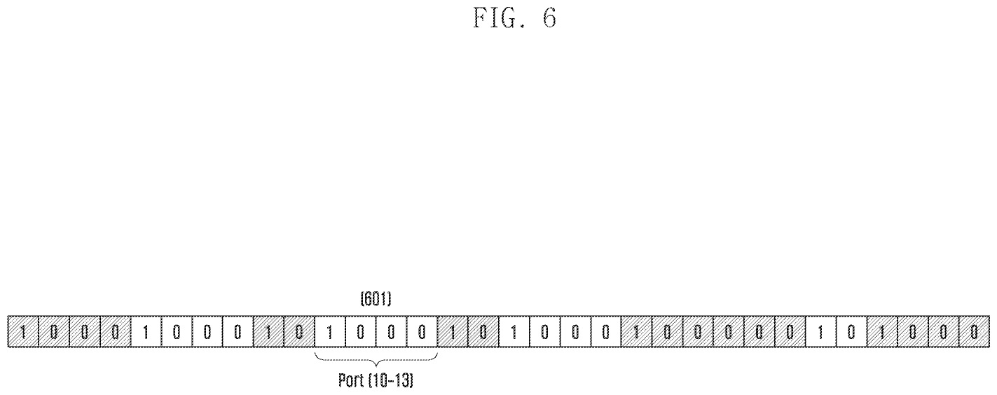

A method that indicates the layout of antenna ports, i.e., a mapping between antenna ports and RRHs, to the UE has a paramount importance for full-duplex DMIMO system as that will enable the UE to figure out which antenna ports belong to the same RRH (are co-located). In Method-1 run-length-based indicator (11), from gNB to the UE, for an exemplary DMIMO setup in FIG. 5 is illustrated in FIG. 6. In this indicator a “1” followed by consecutive “0s” indicates that the ports associated to these fields are co-located and belong to a single RRH. As an example, fields in (601) indicate that the ports (10-13) in (513) of FIG. 5 belong to the same RRH. The indicator I₁ can be configured via RRC configuration under CSI-RS-ResourceMapping information element with examplary field name as portToRRHMapping.

Moreover, as another aspect of Method-1, the indicator (I₁) enables the UE to figure out the number of RRHs in the DMIMO system. In fact, the number of RRHs (N_{RRH}) is the count of “1s” in I₁, which is mathematically given as N_{RRH}=|I₁|₀.

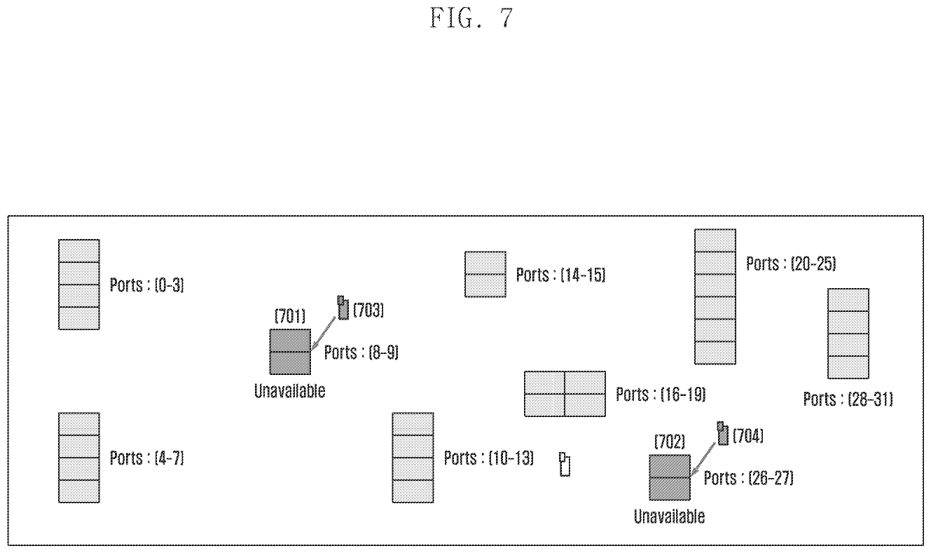

In another aspect of the disclosed invention, a method (Method-2) is provided to indicate the availability of antenna ports for downlink transmission. FIG. 7 illustrates an exemplary DMIMO scenario wherein some antenna ports are not available for downlink transmission. In this example, antenna ports in (701) and (702) are receiving an uplink signal from UEs (703) and (704), respectively. In this particular example if these ports are not capable of operating in full-duplex mode and hence could not also operate in DL transmission mode.

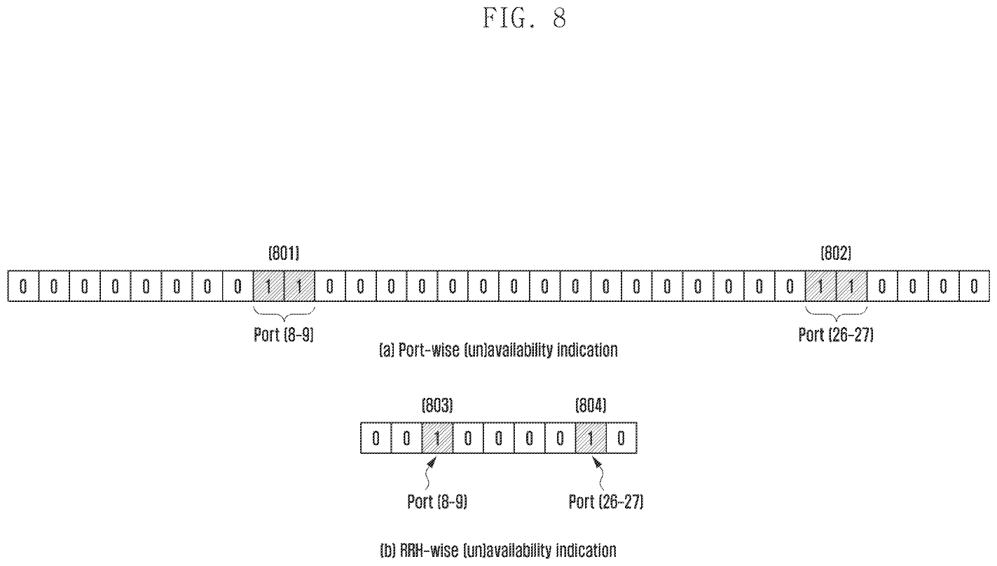

A method (Method 2-1-1) indicates the (un)availability of antenna ports from gNB to the UE for downlink transmission. Method 2-1-1 is based on a bit-map indicator (12) where each bit maps to an antenna port. An exemplary indicator based on Method 2-1-1 for the DMIMO scenario in FIG. 7 is given in FIG. 8 (a). In Method 2-1-1 a bit-map indicator is employed wherein a “1” (801) and (802) indicates the corresponding antenna ports in (701) and (702) is not available for DL transmission. Upon receiving this indicator, the UE figures out which antenna ports are available for DL transmission. In configuration wherein a UE has to compute and feedback a channel state information (CSI) for DL transmission, the UE computes the CSI based on the available antenna ports only. The bit-width of the indicator (12) based on Method 2-1-1 is the same as the number of antenna ports in the DMIMO system.

In another method (Method 2-1-2) an RRH-wise DL transmission (un)availability indication is presented. A corresponding example is also illustrated in FIG. 8(b). Method 2-1-2 similar to Method 2-1-1 employs a bit map-based indication while a “1” (803) and (804) in this indication field indicates the antenna ports within the corresponding RRH (701) and (702) are unavailable for DL transmission. Accordingly, in a system wherein a UE is configured to compute and feedback CSI for DL transmission, upon receiving an indicator based on Method 2-1-2, a UE shall not take the unavailable RRHs and corresponding antenna ports in to account. The bit-width of (un)availability indicator (I₂) based on Method 2-1-2 is the number of RRHs (NRRH) in the DMIMO system. Furthermore, it is to be noted Method 2-1-2, although reduces the required bitwidth as compared to Method 2-1-1, it requires ports-to-RRH mapping indicator (I₁) so that UE identifies the (un)available antenna ports from (un)available RRHs. Moreover, partial indication of antenna ports within an RRH is possible based Method 2-1-1 while it is not possible in Method 2-1-2 even though this feature may not be required in full-duplex DMIMO system.

The (un)available antenna ports indication based on Method 2-1-1 and Method 2-1-2 can have different time domain behaviors. In one exemplary time domain configuration, a method (Method 2-2-1) indicates (12) based on radio resource configuration (RRC) message. One exemplary RRC configuration is given below. In the example, it is assumed that each antenna port is one-to-one mapped to a CSI-RS port and the indications I₁ and I₂ are provided by the fields portToRRHMapping and portAvailblilityIndicator, respectively. Method 2-2-1 is suitable for much stable system wherein self-interference (SI) and cross-link interference (CLI) are measured and reported at layer-3 of a radio access protocol.

CSI-RS-ResourceMapping ::= SEQUENCE {
frequencyDomainAllocation CHOICE {
row1 BIT STRING (SIZE (4)),
row2 BIT STRING (SIZE (12)),
row4 BIT STRING (SIZE (3)),
other BIT STRING (SIZE (6))
},
nrofPorts ENUMERATED {p1,p2,p4,p8,p12,p16,p24,p32},
firstOFDMSymbolInTimeDomain INTEGER (0..13),
firstOFDMSymbolInTimeDomain2 INTEGER (2..12) OPTIONAL, --
Need R
cdm-Type ENUMERATED {noCDM, fd-CDM2, cdm4-FD2-TD2,
cdm8-FD2-TD4},
density CHOICE {
dot5 ENUMERATED {evenPRBs, oddPRBs},
one NULL,
three NULL,
spare NULL
},
freqBand CSI-FrequencyOccupation,
portToRRHMapping BIT STRING (SIZE (nrofPorts))
portAvailabilityIndicator BIT STRING (SIZE (nrofRRHs))
...
}

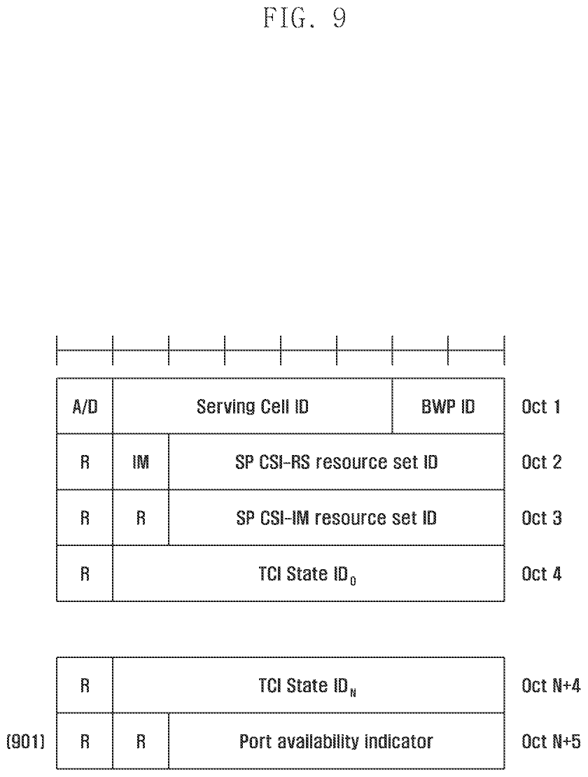

In another variant of a time-domain behavior for I₂ indication, a method (Method 2-2-2) indicates I₂ in medium access control-control element (MAC-CE). An example is given based on Method 2-2-2 in FIG. 9. In FIG. 9, a 6-bits port availability indicator (901) is considered. Method 2-2-2 is suitable for moderately stable system wherein SI and CLI are measured at layer-2 of the radio access protocol.

In another variant of a time-domain behavior for I₂ indication, a method (Method 2-2-3) indicates I₂ along a downlink control information (DCI) triggering aperiodic CSI report. By the same token, Method 2-2-3 is suitable for a dynamic system wherein SI and CLI are measured and reported at layer-1 of radio access protocol.

A UE after acquiring the DMIMO layout with portToRRHMapping and/or portAvailbilityIndicator according to one of the methods in Method 2-2-1 to Method 2-2-3, it may apply a port-selection codebook-based CSI reporting. If the UE is configured with codebookConfig with a filed codebookType set to typeII-portSelection, typeII-portSelction-r16 or typeII-portselection-r17, then the UE indicates the selected ports based on the indicator i_{1,1}.

According to a proposed method (Method 3-1.1), the UE reports the selected ports with a combinatorial indicator:

$${i}_{1 , 1} ∈ \{ 0 , 1 , … , ( \begin{matrix}{P}_{CSI ‐ RS} \\ L\end{matrix} ) - 1 \} \qquad [ Equation 1 ]$$

where P_{CSI-RS} is the number of CSI-RS ports and Z is the number of selected ports configured by nrofPorts and numberOfBeams, respectively. In Method 3-1.1, the UE is not expected to report a value of an indicator i_{1,1} that maps to selected ports consisting a port which is not available for DL transmission. The bitwidth of the indicator based on Method 3-1.1 is given as

$${log}_{2} ( ⌈ ( \begin{matrix}{P}_{CSI ‐ RS} \\ L\end{matrix} ) ⌉ ) .$$

According to a proposed method (Method 3-1.2), the UE reports the selected ports with a combinatorial indicator:

$${i}_{1 , 1} ∈ \{ 0 , 1 , … , ( \begin{matrix}{N}_{R R H} \\ {L}^{′}\end{matrix} ) - 1 \} \qquad [ Equation 2 ]$$

where N_{RRH} is the number of RRHs derived from the nrofPorts and portToRRHMapping. Moreover, the number of selected RRH L′ is set as

$${\sum }_{i = 1}^{{L}^{′}} {P}_{RRH , i} \leq L$$

where P_{RRH,i} is the number of ports on i-th selected RRH indicated by i_{1,1}. P_{RRH,i} is also derived from nrofPorts and portToRRHIndicator. In Method 3-1.2, the UE is not expected to report a value of an indicator i_{1,1} that maps to selected ports consisting a port which is not available for DL transmission. The bitwidth of the indicator based on Method 3-1.2 is given as

$${log}_{2} ( ⌈ ( \begin{matrix}{N}_{R R H} \\ {L}^{′}\end{matrix} ) ⌉ ) .$$

It is to be noted that Method 3-1.2 reduces the number of uplink control information (UCI) bits as compared to Method 3-1.1 while it requires additional RRC configuration filed, i.e., portToRRHMapping.

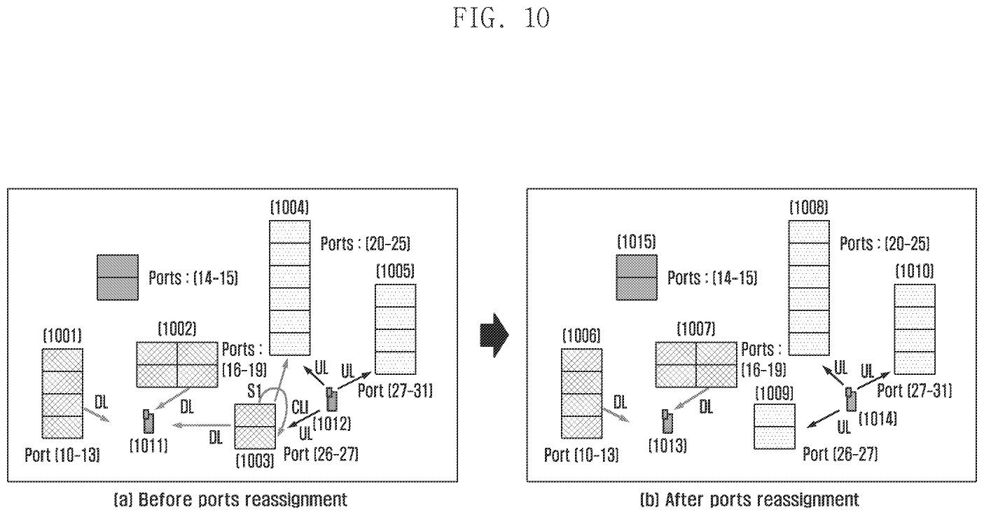

According to another aspect of the invention, methods are presented to update partial CSI triggered by changes in terms of measured CLI and SI. An exemplary scenario that necessitates such partial CSI report is presented in FIG. 10. In the FIG. 10(a), a DL UEs (1011) is served by 3 RRHs, i.e, (1001), (1002) and (1003). Similarly, an UL UEs (1012) is also being served by 3 RRHs, i.e., (1003), (1004) and (1005). In this case, the RRH (1003) is operating in both UL and DL. Suppose, the gNB measured SI at (1003) and CLI from (1003) to (1004) and decided to stop the DL transmission from (1003). The scenario after ports reassignment is shown in FIG. 10(b). In the FIG. 10(b), a DL UEs (1013) is served by 2 RRHs, i.e, (1006) and (1007). Similarly, an UL UEs (1014) is served by 3 RRHs, i.e., (1008), (1009) and (1010). Now the RRH which was a cause SI and CLI before ports reassignment is serving the UL UEs only (1014). Since the ports (26-27) associated with RRH (1009) are removed from DL transmission, its corresponding precoder and CSI components are also changed.

For scenarios, such as the one exemplified with FIG. 10, wherein a subset of ports are removed from a DL transmission towards a certain UE, two methods of CSI update are presented in present disclosure.

In one method (Method 4-1), the gNB (NW) indicates to the UE which ports are going to be removed from downlink transmission. If the UE is configured with codebookConfig with a filed codebookType set to typeII-portSelection, typeII-portSelction-r16 or typeII-portselection-r17, then it is possible to update the precoder at gNB without requesting a new PMI report. Upon reception of such indication the UE may report partial CSI that includes channel quality information (CQI) computed based on a precoder that does not include the removed ports. Moreover, the UE may adjust its quasi co-located (QCL) assumptions by removing the removed ports from QCL related measurements.

As another method (Method 4-2), the gNB (NW) may indicate to the UE which ports are going to be removed from downlink transmission and ask for replacement by triggering partial CSI request. Upon reception of such indication and request a UE may report back a partial precoding matric indication (PMI). This partial PMI may include indices of replacement ports and the corresponding amplitude and phase factors. Moreover, a new CSI based on the updated ports could also be reported. As an example, the DL UE may report ports (14-15) in the RRH (1015) of FIG. 10(b) as replacements of ports (26-27) in the RRH (1009).

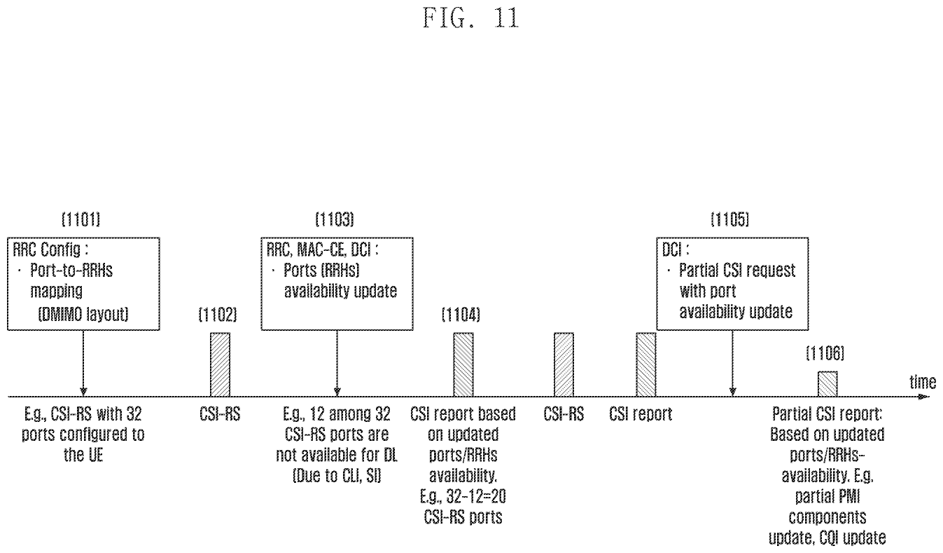

An exemplary time-line and high-level overview of the disclosed invention is illustrated in FIG. 11. In FIG. 11, a gNB/NW first configures a UE with RRC configuration (1101) that contains a ports-to-RRHs mapping. This can be rendered based on Method-1. In this example, a 32 ports CSI-RS resource is configured with a field portToRRHMapping in its CSI-RS-ResourceMapping IE. The UE then receives the corresponding CSI-RS as shown in (1102). Upon reception of a ports availability indicator by either RRC messaging, MAC-CE or DCI (1103), the UE identifies the subset of CSI-RS (antenna) ports for corresponding CSI computation and reporting. Accordingly, the UE may report the corresponding CSI (1104) based on the available ports only. Moreover, a UE may receive a partial CSI request with a corresponding ports availability update via DCI (1105). Upon reception of such request, a UE may update the CSI based on one of the methods described in Method 4-1 or Method 4-2. The illustration in FIG. 11 and its description herein is just for explanatory purpose and by no means limits the application and scope of the disclosed invention. It is also to be noted the messages and signals in FIG. 11 could be transmitted/received with different order without affecting the essence of the disclosed invention.

### Part II: Multi-Panel Codebook-Based Solution

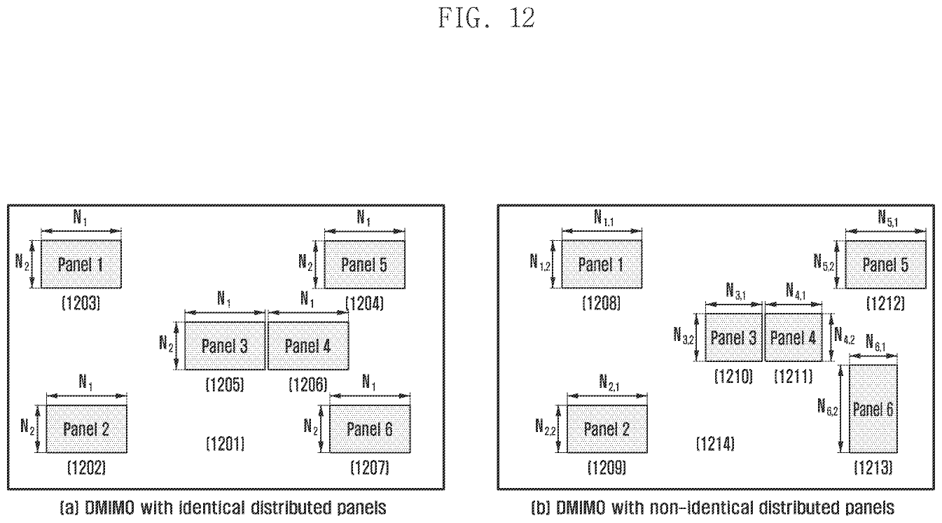

In the following a DMIMO-based full-duplex system is discussed with respect to distributed antenna panels. The solutions disclosed in the following are discussed by taking Type I Multi-Panel codebook-like codebook. However, the disclosed invention is not limited to Type I multi-panel codebook and could be applied to other systems without restriction. FIG. 12 illustrates an exemplary system where antenna panels are distributed over a transmission area. In particular, FIG. 12(a) illustrates a DMIMO system with antenna panels which are identical in size (1201). The multiple antenna panels may be attached to the same RRH (1205) and (1206) while in other cases (1202), (1203), (1204) and (1207), a single antenna panel is attached to an RRH.

In another exemplary setup of DMIMO system, FIG. 12(b) illustrates antenna panels with different sizes distributed over space (1214). Similar to the case discussed in FIG. 12(a), the setup in FIG. 12(b) also considers multiple antennas attached to a single RRH (1210) and (1211), while in other cases (1208), (1209), (1212) and (1213), a single antenna panel is attached to an RRH.

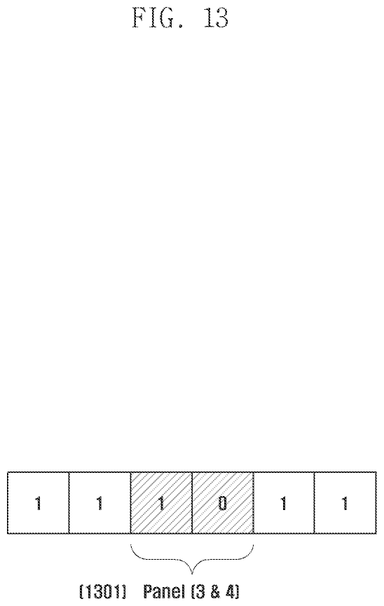

First a multitude of methods to configure the UE with layout of the DMIMO system is provided. When the UE is configured with
i. The number of panels (N_{g})
ii. The number of antenna elements per each dimension (N₁,N₂)
with a higher layer parameter ng-n1-n2, then a method (Method 5-1) configures the UE with additional a run-length based parameter panelToRRHMapping with bitwidth N_{g}. In this method, a “1” followed by “0s” indicates the corresponding panels are colocated. An illustrative example is illustrated in FIG. 13 to indicate panelToRRHMapping based on Method 5-1 corresponding to the exemplary DMIMO setup given in FIG. 12(a). In the given example in FIG. 13, it is shown that the 3^{rd} and 4^{th} panel are collocated (1301).

A method (Method 5-2) configures the UE with portToPanelMapping indicator for a system with non-identical panels. Upon receiving of the parameters
i. The number of CSI-RS ports P_{CSI-RS} in a DMIMO system

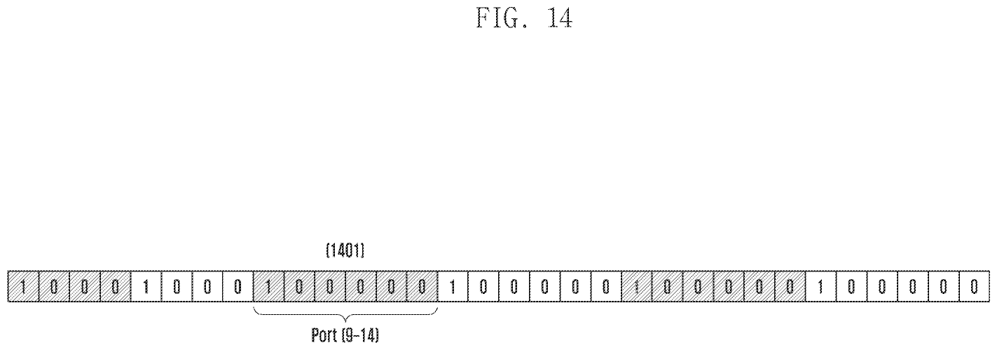

Method 5-2 configures the UE with the higher layer parameter portToPanelMapping that enables the UE to identify the number of CSI-RS ports per each panel. The indicator is based on run-length and a “1” followed by consecutive “0s” indicates the corresponding ports belong to a single panel. In the given example in FIG. 14, it is shown that the antenna ports 9-14 are belong to a single panel (1401). The bitwidth of this indicator is

$$\frac{{P}_{CSI - RS}}{2} .$$

Upon reception of the higher layer parameter portToPanelMapping, the gNB/NW may configure a UE with panelToRRHMapping based on Method 5-1. The UE may derive the number of panels (N_{g}) from the number of “s” in portToPanelMapping.

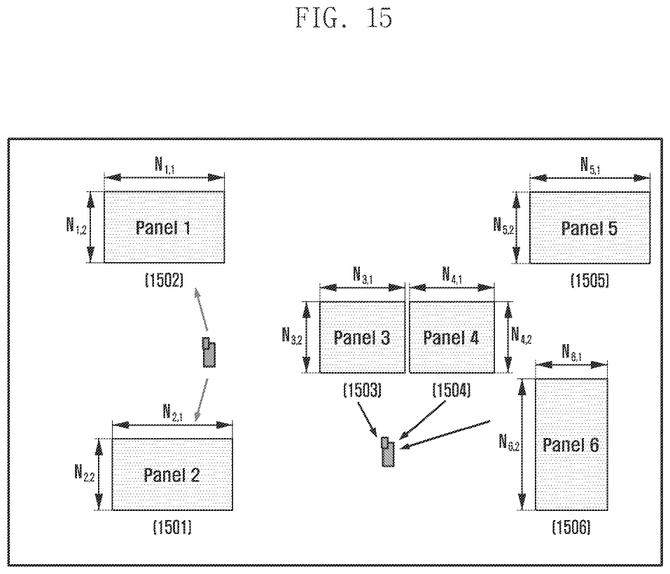

In the following a multitude of methods is presented for the UE to configure a user with the availability of antenna panels. FIG. 15 illustrates an exemplary scenario of multi-panel based DMIMO system wherein a subset of antenna panels is not available for downlink transmission. In the illustrated example, an UL UE is being served by two panels (1501) and (1502). If these antenna panels (panel 1 and 2) are not available for downlink transmission, the gNB/NW may configure/indicate to the UE, the (un)availability of the antenna panels.

A method (Method 6-1-1) indicates the (un)availability of antenna panels from gNB to the UE for downlink transmission. Method 6-1-1 is based on a bit-map indicator (I₃) where each bit maps to an antenna panels. According to an exemplary indicator based on Method 6-1-1 for the DMIMO scenario, it is indicated that the first and second panel are not available for downlink transmission. Upon reception of this indicator a UE figures out, that the CSI computation and reporting is carried out for available panels only.

The (un)available antenna panels indication based on Method 6-1-1 can have different time domain behaviors. In one exemplary time domain configuration, a method (Method 6-2-1) indicates (I₃) based on radio resource configuration (RRC) message. One exemplary RRC configuration is given below. In the example, it is assumed that the indicator I₃ can be configured based on RRC IE panelsAvailabilityIndicator. Method 6-2-1 is suitable for much stable system wherein self-interference (SI) and cross-link interference (CLI) are measured and reported at layer-3 of a radio access protocol.

CodebookConfig ::= SEQUENCE {
codebookType CHOICE {
type1 SEQUENCE {
.
.
.
typeI-MultiPanel SEQUENCE {
mode DMIMO{
nrofPorts CHOICE {32 64 ... 128}
ri-Restriction BIT STRING (SIZE (4))
portsToPanelsMapping BIT STRING (SIZE (nrofPorts)) optional
panelsAvailabilityIndicator BIT STRING (SIZE (nrofPanels))

In another variant of a time-domain behavior for I₃ indication, a method (Method 6-2-2) indicates I₃ in medium access control-control element (MAC-CE). Method 6-2-2 is suitable for moderately stable system wherein SI and CLI are measured at layer-2 of the radio access protocol.

In another variant of a time-domain behavior for I₃ indication, a method (Method 6-2-3) indicates I₃ along a downlink control information (DCI) triggering aperiodic CSI report. By the same token, Method 6-2-3 is suitable for a dynamic system wherein SI and CLI are measured and reported at layer-1 of radio access protocol.

A UE after acquiring the DMIMO layout with portToPanelMapping and/or PanelAvailabilityIndicator according to one of the methods in Method 6-2-1 to Method 6-2-3, it may apply a multi-panel codebook-based CSI reporting. If the UE is configured with codebookConfig with a filed codebookType set to distributedmulti-Panel, then the UE indicates the selected panels based on the indicator i_{1,5}.

According to a proposed method (Method 7-1), the UE reports the selected ports with a combinatorial indicator:

$${i}_{1 , 5} ∈ \{ 0 , 1 , … , ( \begin{matrix}{N}_{g} \\ L\end{matrix} ) - 1 \} \qquad [ Equation 3 ]$$

where N_{g} is the number of panels configured. Moreover, z is the number of panels that can be selected by a UE which is configured by an introduced higher layer parameter numberOfPanels. In Method 7-1, the UE is not expected to report a value of an indicator i_{1,5} that maps to selected panels consisting a panel(s) which is not available for DL transmission. The bitwidth of the indicator based on Method 7-1 is given as

$${log}_{2} ( ⌈ ( \begin{matrix}{N}_{g} \\ L\end{matrix} ) ⌉ ) .$$

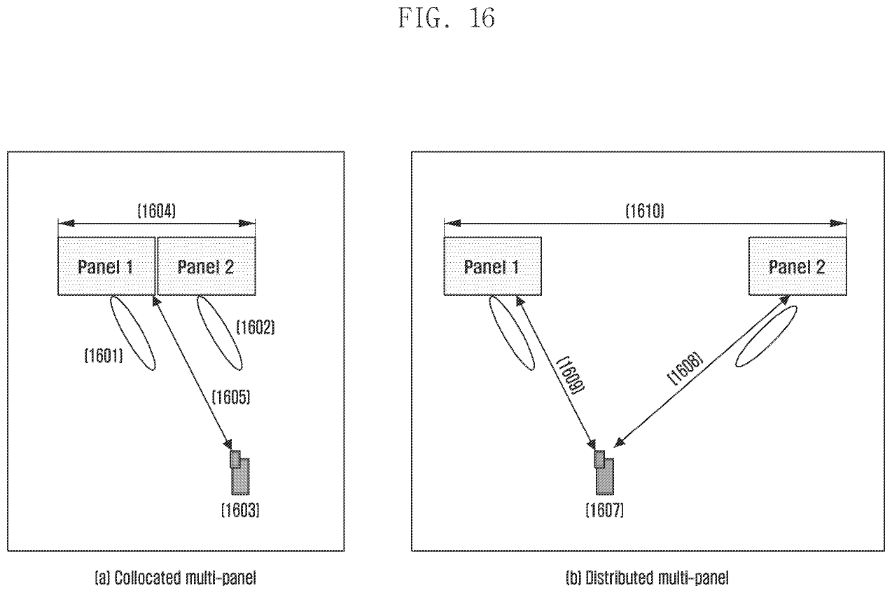

If the UE is configured with codebookConfig with the filed codebookType set to ‘distributed-MultiPanel’, then a proposed method (Method 8-1) enables a UE to indicate independent DFT beam per each antenna panel. In particular a UE reports a set of indicators i_{1,1} and i_{1,2} as:

$${i}_{1 , 1} = \{ \begin{matrix}{i}_{1 , 1} & codebookType = ' typeI - MultiPanel ' \\ [ \begin{matrix}{i}_{1 , 1 , 1} & {i}_{1 , 1 , 2} & … & {i}_{1 , 1 , L} ]\end{matrix} & codebookType = ' distributed - MultiPanel '\end{matrix} \qquad [ Equation 4 ]$$

$${i}_{1 , 2} = \{ \begin{matrix}{i}_{1 , 2} & codebookType = ' typeI - MultiPanel ' \\ [ \begin{matrix}{i}_{1 , 2 , 1} & {i}_{1 , 2 , 2} & … & {i}_{1 , 2 , L} ]\end{matrix} & codebookType = ' distributed - MultiPanel '\end{matrix} \qquad [ Equation 5 ]$$

where i_{1,1,i} and i_{1,2,i} are the DFT beam index indicators in the dimension 1 and 2, respectively. In FIG. 16, an exemplary scenario is illustrated to justify why independent DFT beams per each panel should be reported in distributed multi-panel codebook. In FIG. 16(a), a user served by a collocated panels employs the legacy Rel-15 Multi-panel codebook. In here, as the antenna panels are collocated and as the larger dimension of the collocated panels (1604) is much smaller than the distance (1605) between the UE (1603) and the panels, a single 2-dimensional DFT beam is selected and applied to both panels (see parts (1601) and (1602)). In distributed multipanel system, however, as depicted by an exemplary illustration in FIG. 16(b), selecting two independent 2-dimensional DFT beams each applied to each panel is beneficial. In the pictorial example, the dimension of the two panel including the space (1610) between them is in the same order as the distances (1608, 1609) between the UE (1607) and the two panels. As this entails different ‘best beam directions’ for each panel, independent 2D DFT beam selection and reporting based Method 8-1 is beneficial.

In another aspect of the disclosed invention, a method (Method 8-2) is presented to introduce an amplitude coefficients for distributed multi-panel codebook based transmission. The legacy Rel-15 Multi-panel codebook does not consider an amplitude coefficient as a single 2D DFT beam is applied to the collocated multiple panels. This is justified as the collocated panels are at approximately the same distance from the UE as shown by the illustrative example part (1605) of FIG. 16(a). If the two panels are spatially distributed and have a relatively different distance from the UE, however, introducing amplitude coefficients may provide some benefits.

If the UE is configured with codebookConfig with the filed codebookType set to ‘ distributed-MultiPanel’, then a proposed method (Method 8-2) enables a UE to report amplitude coefficients per each reported 2D DFT beam as

$${i}_{1 , 5} = \{ \begin{matrix}not reported & codebookType = ' typeI - MultiPanel ' \\ [ \begin{matrix}{i}_{1 , 5 , 1} & {i}_{1 , 5 , 2} & … & {i}_{1 , 5 , L} ]\end{matrix} & codebookType = ' distributed - MultiPanel '\end{matrix}$$

where i_{1,5,i} is the amplitude coefficient corresponding to antenna panel
i∈{1,2, . . . ,L}. An example for mapping between the value of i_{1,5,i} and the corresponding amplitude coefficient Pᵢ is given in TABLE 1 when the bitwidth of i_{1,5,i} is set to 3.

TABLE 1

| No. | i_{1, 5, i} | Pᵢ |
|---|---|---|
| 1 | 0 | 0 |
| 2 | 1 | \sqrt{1/64} |
| 3 | 2 | \sqrt{1/32} |
| 4 | 3 | \sqrt{1/16} |
| 5 | 4 | \sqrt{⅛} |
| 6 | 5 | \sqrt{¼} |
| 7 | 6 | \sqrt{½} |
| 8 | 7 | 1 |

Without deviating from the scope of the disclosed invention, one can think of how it can be applied to various codebook types. In one exemplary embodiment, when the codebook type is configured as a ‘typeII-r16’ or ‘typeII-PortSelection-r17’ for coherent joint transmission and a higher layer parameter indicates the configured antenna ports belong to distributed TRPs, then the UE may report the co-scaling amplitude coefficients per each TRP. Let us consider the Rel-16 and Rel-17 codebook based precoder matrix given as w=W₁W₂W_{f}^{H}, where W₁, is the spatial domain (SD) basis matrix, W_{f}^{H} is the frequency domain (FD) basis matrix, and W₂ is a leaner combining (LC) amplitude and phase matrix. Then, the precoder structure for a coherent joint transmission (CJT) from N TRPs can be written as follows

$$W = [ \begin{matrix}{a}_{1} {p}_{1} {W}_{11} {W}_{22} {W}_{f 1}^{H} \\ ⋮ \\ {a}_{N} {p}_{N} {W}_{1 N} {W}_{2 N} {W}_{f , N}^{H}\end{matrix} ]$$

where aᵣ and pᵣ are the co-scaling amplitude and co-scaling phase coefficients for the r-th TRP, r∈{1,2, . . . ,N}, respectively

An exemplary indicator i_{1,9,n} may indicate the TRP-based co-scaling amplitude coefficients for the n-th TRP. In one aspect of the above exemplary embodiment, 3 bits can be allocated for i_{1,9,n}. In this case, Table 1, or a similar mapping table, can be considered for mapping the codepoints of i_{1,9,n} to TRP-specific co-scaling amplitude coefficients.

In some cases, it is beneficial to the base station to be indicated with an indicator for the strongest TRP. Here, the strongest TRP may mean the TRP with the highest coscaling amplitude coefficient or highest when the amplitude coefficients are summed across all the spatial domain (SD) and frequency domain (FD) components, i.e., sum of amplitude coefficients in W_{2,r}for r∈{1,2, . . . , N} and co-scaling amplitude coefficients. In a yet another consideration, a strongest TRP may mean the one which has the strongest amplitude coefficient for its SD and FD components. In this case, as one embodiment of this invention, an additional indicator i_{1,10} can be reported by the UE to indicate the strongest TRP in the reported CSI. If there are/TRPs indicated by higher parameter for CSI reporting or indicated by the UE in its CSI report then the bitwidth of [log ₂(N)] can be used for the indictor to indicate the strongest TRP.

Additionally, in some cases, it is beneficial to report the co-scaling amplitude coefficients with respect to the strongest TRP. In this way, UE may omit reporting the coscaling amplitude coefficient for the strongest TRP and the base station may assume a co-scaling amplitude Pₙ=1 and i_{1,9,n}=7, respectively.

In a yet another embodiment, it is beneficial to report the strongest spatial domain (SD) basis vectors in a polarization specific manner. In fact, as amplitude and phase coefficients are reported for some pairs of FD and SD basis vectors, the strongest SD basis vectors are reported for each layer by the indictor i_{1,8,l}∈{0, 1, . . . , 2L−1} in Rel16 eType II codebook.

In one embodiment, when the codebook type is configured as ‘typeII-r16’ or ‘typeIIPortSelection-r17’ for coherent joint transmission and a higher layer parameter indicates that the configured antenna ports belong to distributed TRPs, then the strongest coefficient for layer 1 across the TRPs can be identified by i_{1,8,l,n}∈{0,1 . . . ,2L−1} and with respect to the strongest TRP indicated by i_{1,10}. Then the amplitude coefficients and phase coefficients are indicated with respect to the strongest component across the TRPs. Let i_{l,n*}*∈={0,1 . . . , 2L−1} be the index of amplitude coefficients which identify the strongest coefficient for layer 1, then the strongest coefficient for layer 1 across the TRPs is identified by i_{1,8,l,n*}∈={0, 1 . . . , 2L−1}, which is obtained as follows

$${i}_{1 , 8 , l , {n}^{* =}} \{ \begin{matrix}{\sum }_{n = 1}^{{n}^{*}} {\sum }_{i = 0}^{{i}_{1 , n}^{*}} {k}_{1 , i , 0 , n}^{( 3 )} & - 1 v = 1 \\ {i}_{l , {n}^{*}}^{*} & 1 < v \leq 4\end{matrix}$$

In a yet another embodiment, when the codebook type is configured as ‘typeII-r16’ or ‘typeII-PortSelection-r17’ for coherent joint transmission and a higher layer parameter indicates the configured antenna ports belong to distributed TRPs, then the strongest coefficient for layer 1 can be reported per each distributed TRP. As an example, the indicator i_{1,8,l,n}∈={0,1, . . . ,2L−1} indicates the strongest coefficient for layer 1 and nth TRP, respectively. Let i_{l,n}*∈={0,1, . . . ,2L−1} be the index of amplitude coefficients which identify the strongest coefficient for layer 1 and n-th TRP, then the strongest coefficient for layer 1 and n-th TRP is identified by i_{1,8,l,n}∈={0, 1, . . . , 2L−1}, which is obtained as follows

$${i}_{1 , 8 , l , n} = \{ \begin{matrix}{\sum }_{i = 0}^{{i}_{1 , n}^{*}} {k}_{1 , i . 0 , n}^{( 3 )} & - 1 υ = 1 \\ {i}_{l , n}^{*} & 1 < υ \leq 4\end{matrix}$$

In a yet another aspect of the presented invention, the amplitude coefficient and phase coefficients of the strongest component indicated by i_{1,8,l,n*} or i_{1,8,l,n} are not reported. The corresponding indicators after remapping with respect to f*_{i,n}∈{0,1, . . . ,Mᵥ−1} are set as “k_{l,i*}_{_{l,n}}_{,0}⁽²⁾=7” and “c_{l,i*}_{_{l,n}}_{,0}=0”, respectively.

When a terminal reports the amplitude and phase coefficients, it is beneficiary to control the reported nonzero coefficients. In one aspect of the invention, the number of nonzero coefficients can be restricted per TRP. Let N be the number of TRPs configured for coherent joint transmission, then the number of nonzero coefficients per TRP can be restricted as

$${K}_{0} = ⌈ \frac{β 2 {LM}_{v}}{N} ⌉$$

where β, L, and Mᵥ are provided by a higher layer parameter. Let the bitmap whose nonzero bits identify which coefficients in i_{2,4,l} and i_{2,5,l} are reported, is indicated by i_{1,7,l}

$$\begin{matrix}{i}_{1 , 7 , {l}^{=}} [ {k}_{l , 0}^{( 3 )} … {k}_{l , N - 1}^{( 3 )} ] \\ {k}_{l , n}^{( 3 )} = [ {k}_{l , n , 0}^{( 3 )} … {k}_{l , n , {M}_{υ} - 1}^{( 3 )} ] \\ {k}_{l , n , f}^{( 3 )} = [ {k}_{l , n , 0 , f}^{( 3 )} … {k}_{l , n , 2 {L}_{y} - 1 , f}^{( 3 )} ] \\ {k}_{l , n , i , f}^{( 3 )} ∈ \{ 0 , 1 \}\end{matrix}$$

for l=1, . . . ,v, such that

$${K}_{l , n}^{N Z} = {\sum }_{i = 0}^{2 L - 1} {\sum }_{f = 0}^{{M}_{v} - 1} {k}_{l , n , i , f}^{( 3 )} \leq {K}_{0}$$

is the number of nonzero coefficients for layer l=1, . . . , v and

$${K}^{N Z} = {\sum }_{l = 1}^{v} {\sum }_{n = 0}^{N - 1} {K}_{l , n}^{NZ} \leq 2 N {K}_{0} .$$

If the strongest component are reported across the TRPs by indicator i_{1,8,l,n*}, then the amplitude and phase coefficient indicators are reported as follows:
The K^{NZ}−v indicators k_{l,n,i,j}⁽²⁾ for which k_{l,n,i,f}⁽³⁾=1, i≠i*_{l,n*},f≠0 are reported
The K^{NZ}−v indicators c_{l,n,i,j}⁽²⁾ for which k_{l,n,i,f}⁽³⁾=1, i≠i*_{l,n*},f≠0 are reported
The remaining 2LNMᵥv−K^{NZ} indicators k_{l,n,i,j}⁽²⁾ are not reported
The remaining 2LNMᵥv−K^{NZ} indicators c_{l,n,i,j}⁽²⁾ are not reported

If the strongest component are reported per TRP and indicated by indicators i_{1,8,l,n} for n=0,1, . . . ,N−1, then the amplitude and phase coefficient indicators are reported as follows:
The K^{NZ}−v indicators k_{l,n,i,j}⁽²⁾ for which k_{l,n,i,f}⁽³⁾=1, i≠i*_{l,n*},f≠0 are reported
The K^{NZ}−v indicators c_{l,n,i,j}⁽²⁾ for which k_{l,n,i,f}⁽³⁾=1, i≠i*_{l,n*},f≠0 are reported
The remaining 2LNMᵥv−K^{NZ} indicators k_{l,n,i,j}⁽²⁾ are not reported
The remaining 2LNMᵥv−K^{NZ} indicators c_{l,n,i,j}⁽²⁾ are not reported

In accordance with an aspect of the present disclosure, a method performed by a user terminal in a wireless communication system is provided. The method includes receiving, from a base station, configuration information on the layout of distributed antenna ports and the availability of antenna ports for downlink transmission. Moreover, the present disclosure discloses a method of computing and reporting CSI based on the configuration from the base station.

In accordance with another aspect of the present disclosure, a method performed by a base station in a wireless communication system is provided, the method includes transmitting, to a terminal, configuration information about the antenna ports layout of a distributed MIMO system. In addition, a configuration information on the availability of distributed antenna ports for downlink data transmission and channel state information (CSI) computation and reporting.

In accordance with another aspect of the present disclosure, a method performed by a user terminal in a wireless communication system is provided, the method includes computing a CSI based on the configuration information received from a base station. The disclosed method includes CSI computation which includes a precoding matrix indication (PMI) computation based on a multi-panel codebook.

In accordance with another aspect of the present disclosure, a method performed by a base station in a wireless communication system is provided, the method includes configuring information regarding a distributed multiple antenna panels. The method includes configuring the user terminal with information regarding the number of antenna ports per a transmission antenna panels at the base station. Moreover, a method to configure a user terminal with information related to the availability of the antenna panels for downlink transmission.

In accordance with another aspect of the presented disclosure, a multi-panel codebook (CB) design is presented which enables a joint precoding across distributed panels in a coherent joint transmission mode.

### Abbreviations

2D Two-dimensional
ACK Acknowledgement
AoA Angle of arrival
AoD Angle of departure
ARQ Automatic Repeat Request
BW Bandwidth
CDM Code Division Multiplexing
CP Cyclic Prefix
C-RNTI Cell RNTI
CRS Common Reference Signal
CRI CSI-RS resource indicator
CSI Channel State Information
CSI-RS Channel State Information Reference Signal
CQI Channel Quality Indicator
DCI Downlink Control Information
dB deciBell
DL Downlink
DL-SCH DL Shared Channel
DMRS Demodulation Reference Signal
eMBB Enhanced mobile broadband
eNB eNodeB (base station)
FDD Frequency Division Duplexing
FDM Frequency Division Multiplexing
FFT Fast Fourier Transform
HARQ Hybrid ARQ
IFFT Inverse Fast Fourier Transform
LAA License assisted access
LBT Listen before talk
LTE Long-term Evolution
MIMO Multi-input multi-output
mMTC massive Machine Type Communications
MTC Machine Type Communications
MU-MIMO Multi-user MIMO
NACK Negative ACKnowledgement
NW Network
OFDM Orthogonal Frequency Division Multiplexing
PBCH Physical Broadcast Channel
PDCCH Physical Downlink Control Channel
PDSCH Physical Downlink Shared Channel
PHY Physical layer
PRB Physical Resource Block
PMI Precoding Matrix Indicator
PSS Primary Synchronization Signal
PUCCH Physical Uplink Control Channel
PUSCH Physical Uplink Shared Channel
QoS Quality of service
RAN Radio access network
RAT Radio access technology
RB Resource Block
RE Resource Element
RI Rank Indicator
RRC Radio Resource Control
RS Reference Signals
RSRP Reference Signal Received Power
SDM Space Division Multiplexing
SINR Signal to Interference and Noise Ratio
SPS Semi-Persistent Scheduling
SRS Sounding RS
SF Subframe
SSS Secondary Synchronization Signal
SU-MIMO Single-user MIMO
TDD Time Division Duplexing
TDM Time Division Multiplexing
TB Transport Block
TP Transmission point
TRP Transmission reception point
TTI Transmission time interval
UCI Uplink Control Information
UE User Equipment
UL Uplink
UL-SCH UL Shared Channel
URLLC Ultra-reliable low-latency communication

1. A user equipment (UE) in a communication system, the UE comprising:
a transceiver; and
a controller configured to:
receive, from a base station, configuration information associated with a multiple transmit-receive points (TRPs),
identify amplitude coefficients associated with the multiple TRPs based on the configuration information, and
transmit, to the base station, a channel state information (CSI) report includes indicators indicating the amplitude coefficients associated with the multiple TPRs.

2. The UE of claim 1, wherein the CSI report includes an indicator indicating co-scaling amplitude coefficients per each TRP.

3. The UE of claim 2, wherein the CSI report includes an indicator indicating the strongest TRP among the multiple TRPs, and a co-scaling amplitude coefficient for the strongest TRP being not reported by the CSI report.

4. The UE of claim 1, wherein the CSI report includes an indicator indicating the strongest coefficient per layer across the multiple TRPs, or an indicator indicating the strongest coefficient per layer per TRP.

5. The UE of claim 1, wherein a number of non-zero coefficients included in the CSI report is restricted per TRP or across the multiple TRPs.

6. A base station in a communication system, the base station comprising:
a transceiver; and
a controller configured to:
transmit, to a user equipment (UE), configuration information associated with a multiple transmit-receive points (TRPs), and receive, from the UE, a channel state information (CSI) report includes indicators indicating the amplitude coefficients associated with the multiple TPRs based on the configuration information.

7. The base station of claim 6, wherein the CSI report includes an indicator indicating co-scaling amplitude coefficients per each TRP.

8. The base station of claim 7, wherein the CSI report includes an indicator indicating the strongest TRP among the multiple TRPs, and a co-scaling amplitude coefficient for the strongest TRP being not reported by the CSI report.

9. The base station of claim 6, wherein the CSI report includes an indicator indicating the strongest coefficient per layer across the multiple TRPs, or an indicator indicating the strongest coefficient per layer per TRP.

10. The base station of claim 6, wherein a number of non-zero coefficients included in the CSI report is restricted per TRP or across the multiple TRPs.

11. A method performed by a user equipment (UE) in a communication system, the method comprising:
receiving, from a base station, configuration information associated with a multiple transmit-receive points (TRPs);
identifying amplitude coefficients associated with the multiple TRPs based on the configuration information; and
transmitting, to the base station, a channel state information (CSI) report includes indicators indicating the amplitude coefficients associated with the multiple TPRs.

12. The method of claim 11, wherein the CSI report includes an indicator indicating co-scaling amplitude coefficients per each TRP,
wherein the CSI report includes an indicator indicating the strongest TRP among the multiple TRPs, and a co-scaling amplitude coefficient for the strongest TRP being not reported by the CSI report.

13. The method of claim 11, wherein the CSI report includes an indicator indicating the strongest coefficient per layer across the multiple TRPs, or an indicator indicating the strongest coefficient per layer per TRP.

14. The method of claim 11, wherein a number of non-zero coefficients included in the CSI report is restricted per TRP or across the multiple TRPs.

15. A method performed by a base station in a communication system, the method comprising:
transmitting, to a user equipment (UE), configuration information associated with a multiple transmit-receive points (TRPs); and
receiving, from the UE, a channel state information (CSI) report includes indicators indicating the amplitude coefficients associated with the multiple TPRs based on the configuration information.
